(19) United States
(12) Patent Application Publication
(10) Pub. No.: US 2011/0121108 A1
(43) Pub. Date: May 26, 2011

(54) PLASMA POLYMERIZATION NOZZLE

(76) Inventors: Stephan Rodewald, Canal Fulton, OH (US); Frederic Gerard Auguste Siffer, Akron, OH (US)

(21) Appl. No.: 12/624,828

(22) Filed: Nov. 24, 2009

(51) Int. Cl. B05B 1/00

(52) U.S. Cl. 239/589; 222/566

(57) ABSTRACT

A nozzle provides plasma polymerization on a cylindrical surface of an object. The nozzle includes a cylindrical body having a longitudinal axis, a coaxial cylindrical inlet for receiving plasma and the object, a radial inlet for receiving an organic precursor, and a mixing chamber for receiving the plasma and the object from the coaxial cylindrical inlet thereby providing mixing of the plasma and the organic precursor and a uniform deposition of polymer on the cylindrical surface of the object.

### FIELD OF THE INVENTION

The present invention relates to a nozzle for coating a substrate, and more particularly, to a nozzle for coating a substrate through atmospheric plasma polymerization.

### BACKGROUND OF THE INVENTION

In producing many articles, often it is necessary to join dissimilar materials. In many cases, one or both of the materials must have their surface properties adjusted. Adjustment of surface properties of materials in manufacturing often involves surface treatment technology. Non-limiting examples of these surface properties include surface energy, chemical inertness, conductivity, dye reception, and adhesion. Non-limiting examples of applications using surface treatment and preparation include anti-corrosion coatings on corrodible metals such as iron and steel; bio-compatible coatings on internal implants; waterproof layers on electronics; and inorganic and organic materials for tires.

Application of coatings, adhesives, sealants, and elastomers (CASE) to substrates often requires particular care in treating or pre-treating the surface to avoid adhesive failure between the substrate and the applied CASE compounds. Many CASE application processes involve steps of (a) cleaning or roughening the surface, (b) applying a primer that either bonds to the surface or etches it, and/or (c) applying an enhancement agent that adds additional bonding functionality. CASE compounds are used in industries including construction, automotive, medical, dental, labeling, electronics, and packaging.

In the automotive industry, CASE compounds are used in conjunction with rubber reinforcement processes. Disadvantageously, rubber reinforcement is susceptible to cracking due to poor adhesion of the reinforcement to the rubber. Other goals of joining dissimilar materials include improving accuracy of manufacturing, productivity, levels of automation, reliability, and/or manufacturability, while decreasing harmful side effects, quantity of materials used, and/or waste of energy and materials. For example, some CASE compounds have substantial amounts of waste. Often coupling agent primers are less than 1% active agent and 99% carrier solvent. In another example, cleaning materials have harmful side effects such as flammability and/or noxious solvents, such as isopropyl alcohol or toluene. In other cases, paint-like layers often have to air dry within 30 seconds and so use volatile solvents. Energy and money are wasted to remediate these emissions and to protect workers' health.

Plasma polymerization has been developed as a tool to modify material surfaces while improving manufacturability, levels of automation, and accuracy of manufacturing, while decreasing harmful side effects as well as waste of energy and materials. There are different types of plasmas that are defined by their output temperature, their pressure conditions, as well as the equilibration state regarding the chemistry and thermal state. For example, there are plasmas created under subambient pressure conditions. Examples include a high plasma density mode and a low plasma density mode plasma generated with a magnetron, which is typically used in physical vapor deposition. Other ambient pressure examples include glow discharge, inductively-coupled, and recombining plasmas. The glow discharge is characterized by low velocity movement of gas of a few meters/second. It features both thermal and chemical non-equilibrium. An inductively-coupled plasma has low to moderate gas movement. It features local thermal equilibria. The recombining nitrogen or air plasmas have high gas velocities of approximately 1 km/sec and feature chemical equilibria. Additional examples of classes of plasmas are determined by their ionization methods, such as microwave resonance and electrical discharge.

When plasmas are applied to high volume production processes outside a laboratory, additional manufacturability and automation considerations arise, such as speed of operation, compatibility with substrates, and contamination. In many applications, the plasma treatments occur quickly, typically on the order of nanoseconds to a few minutes, which effectively preclude batch vacuum techniques such as physical vapor deposition.

The high temperature plasmas may thermally combust or thermally shock substrates, especially ones with low thermal conductivity as well as low melting or combustion points. In addition, some surfaces are imperfect, such as those having dust, organic body oils, and debris from shipment and handling. In light of the foregoing, a method that improves accuracy of manufacturing, productivity, levels of automation, reliability, and/or manufacturability while decreasing harmful side effects, quantity of materials used, and/or waste of energy and materials for a high volume production process for preparing a surface for joining two dissimilar materials or to receive CASE compounds.

One conventional method deposits a coating on to a clean surface during a first time period, and depositing a high-velocity impact polymer reaction coating on the surface at ambient air pressure during a second time period using an atmospheric pressure air plasma (APAP). Another conventional method may apply a coating of mixed prepolymer vapor and carrier gas or mist of small droplets. That mixture may be introduced into an atmospheric pressure air plasma to form a polymer reaction compound. The polymer reaction compound may then be applied with high-velocity impact driven by the exiting gases of the APAP.

### SUMMARY OF THE INVENTION

A nozzle in accordance with the present invention provides plasma polymerization on a cylindrical surface of an object. The nozzle includes a cylindrical body having a longitudinal axis, a coaxial cylindrical inlet for receiving plasma and the object, a radial inlet for receiving an organic precursor, and a mixing chamber for receiving the plasma and the object from the coaxial cylindrical inlet thereby providing mixing of the plasma and the organic precursor and a uniform deposition of polymer on the cylindrical surface of the object.

According to another aspect of the present invention, the coaxial cylindrical inlet is defined by a predetermined length for protecting the object from premature deposition of polymer for the predetermined length.

According to still another aspect of the present invention, the object is a tire bead.

According to yet another aspect of the present invention, the radial inlet has a cylindrical shape.

According to still another aspect of the present invention, the organic precursor is transported through the radial inlet by a carrier gas.

According to yet another aspect of the present invention, the organic precursor is transported as a mist through the radial inlet by a carrier gas.

### BRIEF DESCRIPTION OF THE DRAWINGS

FIG. 1 shows a schematic representation of an example of deposition of a high-velocity impact polymer reaction coating onto a surface in accordance with the present invention.

FIG. 2 shows a schematic representation of a conventional plasma polymerization nozzle.

FIG. 3 shows a schematic representation of a plasma polymerization nozzle in accordance with the present invention.

### DESCRIPTION OF AN EXAMPLE EMBODIMENT OF THE PRESENT INVENTION

Reference will now be made in example detail to compositions, embodiments, and methods of the present invention known to the inventors. However, it should be understood that disclosed embodiments are merely exemplary of the present invention which may be embodied in various and alternative forms. Therefore, specific details disclosed herein are not to be interpreted as limiting, rather merely as representative bases for teaching one skilled in the art to variously employ the present invention.

Except where expressly indicated, all numerical quantities in this description indicating amounts of material or conditions of reaction and/or use are to be understood as modified by the word “about” in describing the broadest scope of the present invention.

The description of a group or class of materials as suitable for a given purpose in connection with the present invention implies that mixtures of any two or more of the members of the group or class are suitable. Description of constituents in chemical terms refers to the constituents at the time of addition to any combination specified in the description, and does not necessarily preclude chemical interactions among constituents of the mixture once mixed. The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

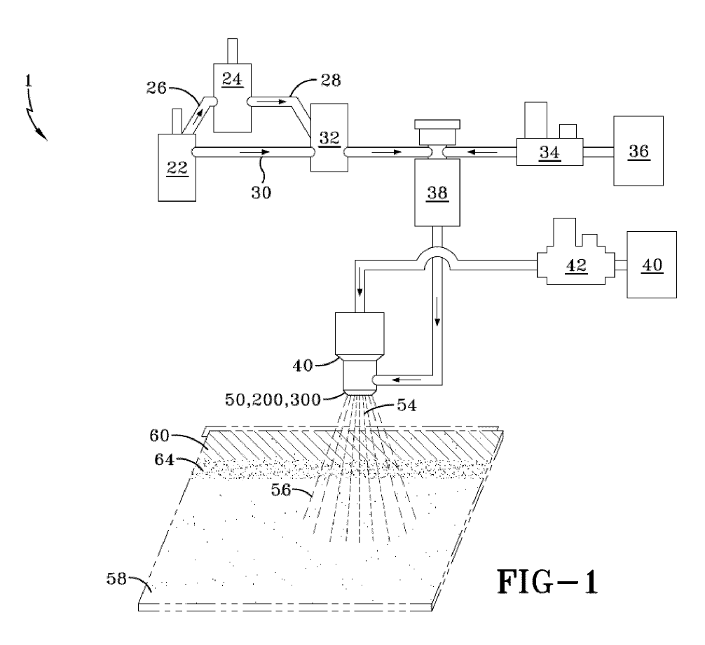

Referring to FIG. 1, in an example atmospheric pressure air plasma (APAP) system 1, a polymerizable material in the form of prepolymer in a feedstock vessel 22 may be supplied in metering tube 30 using a mass flow controller 32 and vaporized and mixed with a carrier gas in mixing chamber 38. The carrier gas may be supplied from a carrier gas feedstock vessel 36 and introduced through a meter 34 into the mixing chamber 38. This mixture may be introduced into an atmospheric pressure air plasma apparatus 44 containing the plasma of ionized gas. The ionized gas may come from a ionization gas feedstock vessel 40 through a meter 42. The ambient air pressure around the air plasma apparatus 44 may range from greater than 50 kilopascals, 75 kilopascals, or 100 kilopascals, and less than 300 kilopascals, 250 kilopascals, 200 kilopascals, or 150 kilopascals. At an exit nozzle 50, the high-velocity polymer reaction coating may achieve velocities greater than 10-m/s, 50-m/s, or 75-m/s, and less than 200-m/s, 150-m/s, or 125-m/s. The gases may exit the nozzle 50 at a temperature less than 450° C., 400° C., 350° C., 325° C., or 300° C., and greater than 70° C., 100° C., 125° C., or 150° C. The temperature of the substrate 58 may be less than 95° C., 85° C., 75° C., 70° C., 65° C., 60° C., 55° C., or 50° C., depending upon the conditions of operation. This temperature at the substrate 58 allows this process to work with substrates that are susceptible to heat damage.

The gases from the exit nozzle 50 may be a spray pattern with the outer penumbra 56 having mostly ionized gas for cleaning and/or activating. Closer to the center of the spray pattern may be an area of the higher concentration 54 of high-velocity impact polymer reaction coating material. The substrate 58 receiving the high-velocity impact polymer reaction coating 64 may be a rubber reinforcement material.

The substrate 58 may be activatable by ionization and heat and may be in pristine condition, having a covering of debris, or be corroded. The substrate 58 may be cleaned, and partially activated, by an atmospheric pressure air plasma. When the atmospheric pressure air plasma is also a device depositing high-velocity impact polymer coatings, the penumbra 56 of the atmospheric pressure air plasma exiting from the nozzle 50 may have a cleaning function associated with the ionization and heat. Accordingly, the time period between the cleaning and/or activation step and the deposition step may be greater than 1 ms, 5 ms, 10 ms, 25 ms, or 100 ms.

One or more separate atmospheric pressure air plasmas may be provided to clean and/or activate the surface, followed by one or more separate atmospheric pressure air plasmas depositing high velocity impact polymer coatings. The APAPs may be operated in a sequential manner, in a parallel manner, or a combination thereof. When operated as a parallel set of multi-APAPs, typical spacing may be about 2 mm.

The cleaning and/or activating operation may be capable of operating at higher travel speeds than the deposition operation or a combined cleaning and/or activating operation, as well as a deposition operation. A cleaning operation using broader width passes and a deposition operation using raster-type passes may also be included. The cleaning and/or activating operation may be accomplished using other ionization technologies, such as corona discharge or combustion sources. The time periods between the cleaning/activation step and deposition may be greater then 0.1 s, 1 s, 5 s, 10 s, 25 s, or 100 s, and less than 150 s, 300 s, 600 s, 1800 s, 3600 s, 12 hr, 1 day, 2 days, or 5 days.

Gradients of prepolymers may be developed where an additional feedstock vessel 24 holding other prepolymers feeds through a supply line 26 to the prepolymer feedstock vessel 22 in order to incrementally adjust the ratio or ratios of the prepolymers in the feedstock. Other prepolymers may be fed through a supply line 28 to a metering device 32 that may be adjusted incrementally or step-wise based on the ratio or ratios of prepolymers.

The APAP may deliver a plasma air treatment to the substrate 58 to reactivate the substrate. For example, the substrate 58 may be cleaned and coated in one location, and then shipped to a second location for reactivation at a later time.

Plasma polymerization yields polymers in arrangements not typically found under normal chemical conditions. The polymers may be have highly branched chains, randomly terminated chains, or functional crosslinking sites. Absent are regularly repeating units, in general. This is a result of the fragmentation of the prepolymer molecules when they are exposed to the high-energy electrons inherent in the plasma. The reactions appear to proceed by several reaction pathways including free radical formation, homolytic cleavage, cationic oligomerization, and combinations thereof.

The deposit resulting from reaction in an atmospheric pressure air plasma differs from some conventional polymers, oligomers, and monomers. In some conventional monomers, oligomers, and polymers, there is a standard series of one or more building block units, also called mers. As the polymeric chains grow the building block units are repeated and occasionally cross-linked. In a plasma polymer, the building block units may be fragmented and have new functional groups developed. When they recombine, there may be generally higher crosslink density, an increased presence of branched chains, randomly terminated chains, or a combination thereof. The crosslink density calculation becomes more difficult as the number of cross links divided by the number of backbone atoms approaches unity. Such may be the case in plasma polymers. A relative measure of the crosslink density may be the shift in glass transition temperature relative to the conventional polymer. One may expect that at low degrees of crosslinking the shift upwards of the glass transition temperature will be to the number of crosslinks. In plasma polymers, the slope of the proportion may increase relatively by about 10%, 15%, or 20% compared to conventional polymers.

Prepolymers that may be suitable for deposition by atmospheric pressure air plasma include compounds that can be vaporized. The vapors may be metered and blended with a carrier gas. This mixture of gases may be introduced into a plasma generated by an atmospheric pressure air plasma. The ionization gas of the atmospheric pressure air plasma may be chosen from gases typical of welding processes which may include, but are not limited to, noble gases, oxygen, nitrogen, hydrogen, carbon dioxide, and combinations thereof.

Prepolymers used to create a high velocity impact polymer coating may include, but are not limited to, reactive substituted compounds of group 14. Candidate prepolymers do not need to be liquids, and may include compounds that are solid but easily vaporized. They may also include gases that compressed in gas cylinders, or are liquefied cryogenically and vaporized in a controlled manner by increasing their temperature.

It would be desirable to coat the external surface of tire beads or cords to promote adhesion to the surrounding bead area rubber compound matrix. As described above, plasma deposition of polymerizable material and in-situ polymerization/crosslinking via ions of the plasma may produce films which promote adhesion to a substrate, such as rubber. The effectiveness of this method partially depends on the uniform deposition of a very thin film of the adhesion promoter.

A conventional plasma nozzle may be modified in accordance with the present invention to allow the continuous and concentric feed-through of a bead, cord, or any other elongated cylindrical object. A central bore of the modified nozzle may enable the elongated cylindrical object to pass through a center of a plasma stream, resulting in a uniform exposure of the elongated cylindrical object's surface to the plasma, and the uniform deposition of adhesion promoter.

The nozzle of the present invention thus provides uniform plasma deposition of adhesion coatings on tire beads and cords that may significantly reduce cost and enhance tire properties relative to conventional nozzles. Conventionally, plasma nozzles were merely passed along one side of the bead leading to a non-uniform surface coating. Multiple passes along different sides of the bead improved the coating uniformity, though not significantly enough. Further, these multiple passes increased the process time and the amount of reagent used. Use of the plasma nozzle of the present invention, with a concentric fee-through of the bead, allows for the single-pass treatment of the bead while minimizing the consumption of coating reagent.

A conventional plasma polymerization nozzle 200, as in FIG. 2, may consist of a metallic mixing chamber 210 where an organic precursor 201 is injected upstream and completely mixed with a plasma stream 203 prior to coming out of a round-shaped nozzle. As described above, this type of nozzle does not efficiently produce a uniform coating of a tire bead.

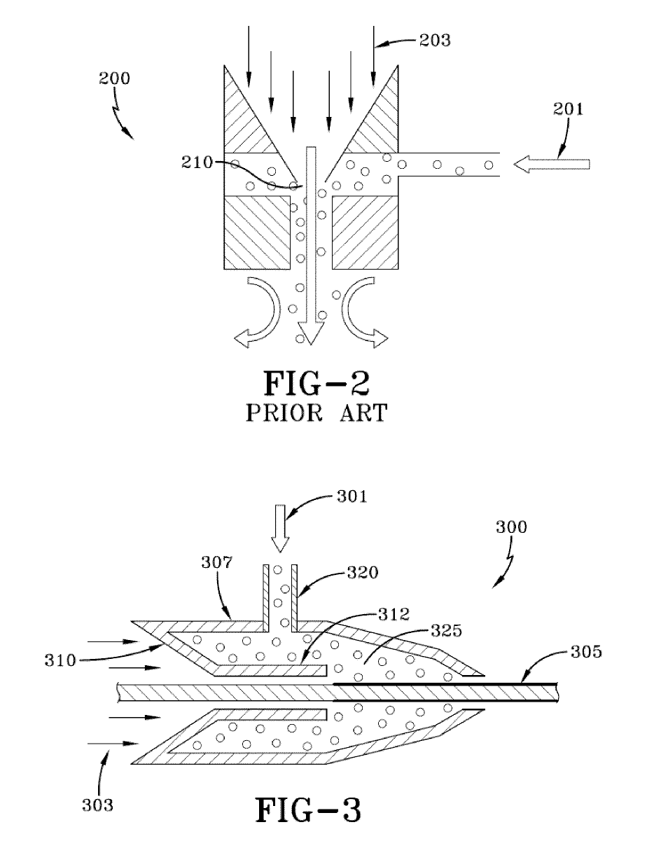

As shown in FIG. 3, a nozzle 300 in accordance with the present invention has a cylindrical body 307 with a coaxial and conical inlet 310 for receiving the plasma 303 and the tire bead 305 and a radial inlet 320 for receiving the organic precursor 301. The plasma 303 and tire bead 305 pass axially from the conical inlet 310 through a cylindrical shield chamber 312 having a diameter only somewhat larger than the tire bead itself. The axial length of the cylindrical shield chamber 312 may protect the tire bead 305 from premature deposition of the polymer (i.e., before appropriate mixing can occur). The plasma 303 and the tire bead 305 then pass axially into a mixing chamber 325. The organic precursor 301 passes radially from the radial inlet 320 to the mixing chamber 325 of the nozzle 300. Mixing of the plasma 303 and the organic precursor 301 occurs in the mixing chamber 325, thereby surrounding the cylindrical surface of the tire bead 305 and depositing a thin uniform polymer coating on the entire surface of the tire bead. The tire bead 305 may be fed through the nozzle 300 thereby providing a continuous process for coating tire bead stock of any length.

While the best mode for carrying out the invention has been described in detail, those familiar with the art to which the present invention relates will recognize various alternative designs and embodiments for practicing the invention as defined by the following claims.

What is claimed is:

1. A nozzle for plasma polymerization on a cylindrical surface of an object, the nozzle comprising:
a cylindrical body having a longitudinal axis;
a coaxial cylindrical inlet for receiving plasma and the object;
a radial inlet for receiving an organic precursor; and
a mixing chamber for receiving the plasma and the object from the coaxial cylindrical inlet thereby providing mixing of the plasma and the organic precursor and a uniform deposition of polymer on the cylindrical surface of the object.

2. The nozzle as set forth in claim 1 wherein the coaxial cylindrical inlet is defined by a predetermined length for protecting the object from premature deposition of polymer for the predetermined length.

3. The nozzle as set forth in claim 1 wherein the object is a tire bead.

4. The nozzle as set forth in claim 1 wherein the radial inlet has a cylindrical shape.

5. The nozzle as set forth in claim 1 wherein the organic precursor is transported through the radial inlet by a carrier gas.

6. The nozzle as set forth in claim 1 wherein the organic precursor is transported as a mist through the radial inlet by a carrier gas.
